(19) United States
(12) Patent Application Publication
(10) Pub. No.: US 2016/0079863 A1
(43) Pub. Date: Mar. 17, 2016

(54) POWER CONVERTER AND DRIVING METHOD FOR THE SAME

(71) Applicant: SAMSUNG ELECTRO-MECHANICS CO., LTD., Suwon-si (KR)

(72) Inventors: Min Jin KIM, Suwon-si (KR); Jung Mun CHOI, Busan-si (KR); Ki Hong KIM, Suwon-si (KR)

(73) Assignee: SAMSUNG ELECTRO-MECHANICS CO., LTD., Suwon-si (KR)

(21) Appl. No.: 14/815,284

(22) Filed: Jul. 31, 2015

(30) Foreign Application Priority Data
Sep. 15, 2014 (KR) 10-2014-0121901

(51) Int. Cl. H02M 3/335

(52) U.S. Cl. CPC H02M 3/33507

(57) ABSTRACT

Provided is a power converter, which includes: a power supply unit provided with a first wiring and a second wiring and configured to apply a driving voltage to a load, the power supply unit being configured to adjust a magnitude of the driving voltage in response to a turn ratio of the first wiring to the second wiring; and control unit configured to output a control signal for control the turn ratio of the first wiring to the second wiring based on the magnitude of the driving voltage.

### CROSS-REFERENCE TO RELATED APPLICATIONS

Claim and incorporate by reference domestic priority application and foreign priority application as follows:

### CROSS REFERENCE TO RELATED APPLICATION

This application claims the foreign priority benefit under 35 U.S.C. Section 119 of Korean Patent Application Serial No. 10-2014-0121901, entitled filed Sep. 15, 2014, which is hereby incorporated by reference in its entirety into this application.

### BACKGROUND OF THE INVENTION

### 1. Field of the Invention

Embodiments of the present invention relates to a power converter and a driving method for the same.

In general, a power converter for LED lighting controls current to be applied to a LED module at a constant level, thus maintains a constant level of brightness. To do this, the LED lighting power converter uses methods such as PWM (Pulse Width Modulation) or PFM (Pulse Frequency Modulation). For the LED module, a LED forward voltage (Vf) is determined according to the number of LEDs which are connected in parallel and/or in serial to one another, and consumption powers of the respective LEDs. In addition, the LED lighting power converter has a limited range of output voltage. When Vf of the LED module falls within the range, the LED lighting power converter controls an electric current to be applied to the LED module such that the LED module emits a desired light at a constant level. Meanwhile, when Vf of the LED module is out of the range, the LED lighting power converter cannot control the electric current, thus failing to emit light of a constant level.

### SUMMARY OF THE INVENTION

The present invention has been invented in order to overcome the above-described problems and it is, therefore, an object of the present invention to provide a power converter and a driving method therefor, which are capable of generating an output voltage of a broad range.

According to one embodiment of the present disclosure, there is provided a power converter, which includes: a power supply unit provided with a first wiring and a second wiring and configured to apply a driving voltage to a load, the power supply unit being configured to adjust a magnitude of the driving voltage in response to a turn ratio of the first wiring to the second wiring; and control unit configured to output a control signal for control the turn ratio of the first wiring to the second wiring based on the magnitude of the driving voltage.

According to another embodiment of the present disclosure, there is provided a power converter, which includes: a first wiring through which an electric current flows in response to an input voltage; a first sub-wiring to which a driving voltage is induced according to a variation in the electric current flowing through the first wiring; a second sub-wiring to which the driving voltage is induced according to the variation in the electric current flowing through the first wiring; third sub-wiring to which the driving voltage is induced according to the variation in the electric current flowing through the first wiring; a fourth sub-wiring to which the driving voltage is induced according to the variation in the electric current flowing through the first wiring; a first switch connected between the other terminal of the first sub-wiring and one terminal of the second sub-wiring; a second switch connected between the other terminal of the third sub-wiring and one terminal of the fourth sub-wiring; a first diode connected between one terminal of the first sub-wiring and an output terminal; a second diode connected between the first switch and the output terminal; a third diode connected between the second switch and the output terminal; a fourth diode connected between the other terminal of the fourth sub-wiring and the output terminal; and a control unit configured to output a first control signal for controlling turn-on or turn-off operations of the first switch and the second switch.

According to another embodiment of the present disclosure, there is provided a power supply method of determining a driving voltage to be applied to a load based on a turn ratio of a first wiring to a second wiring, the method including; comparing the driving voltage with a reference voltage; and adjusting the turn ratio of the first wiring to the second wiring by blocking a flow of a driving current to a portion of the second wiring based on the comparison result between the driving voltage with the reference voltage.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a structure view of a power converter according to an embodiment of the present disclosure;

FIG. 2 is a circuit view of the power converter shown in FIG. 1 according to a first embodiment;

FIG. 3 is a circuit view of the power converter shown in FIG. 1 according to a second embodiment;

FIG. 4 is a circuit view of the power converter shown in FIG. 1 according to a third embodiment; and

FIG. 5 is a flowchart showing a sequence of processes for generating power using the power converter shown in FIG. 1.

### DESCRIPTION OF EMBODIMENTS

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

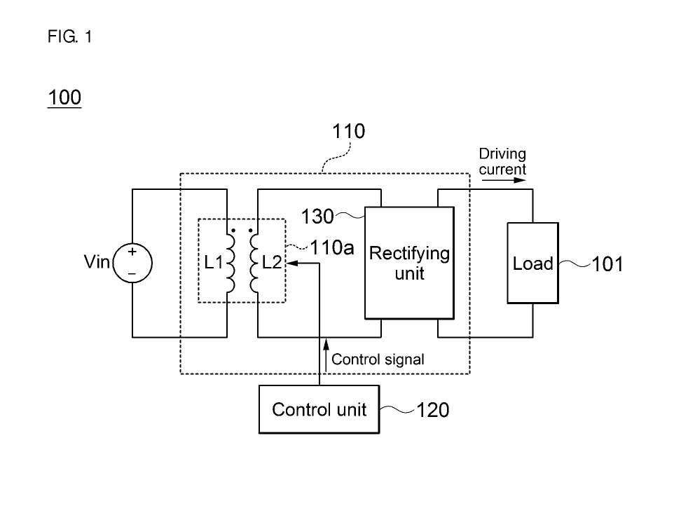

FIG. 1 is a structure view of a power converter according to an embodiment of the present disclosure.

As shown in FIG. 1, a power converter 100 includes a first wiring L1 and a second wiring L2. The power converter 100 further includes a power supply unit 110 and a control unit 120. The power supply unit 110 applies a driving voltage whose magnitude is adjusted in response to a turn ratio of the first wiring L1 to the second wiring L2, to a load 101. The control unit 120 outputs a control signal for adjusting the turn ratio of the first wiring L1 to the second wiring L2 in response to the magnitude of the drive voltage.

The power supply unit 110 applies the driving voltage to the second wiring L2 based on a change in electric current flowing through the first wiring L1. In other words, the power supply unit 110 includes a transformer 110a provided with the first wiring L1 and the second wiring L2. In addition, the power supply unit 110 may include an LLC converter, a flyback converter or the like.

The control unit 120 is configured to adjust the turn ratio of the first wiring L1 to the second wiring L2. Specifically, the control unit 120 outputs a control signal to induce a driving current to the entire of the second wiring L2 using the electric current flowing along the first wiring L1. In addition, the control unit 120 outputs a control signal to select a portion of the second wiring L2 and induce the driving current to the selected portion of the second wiring L2 using the electric current flowing along the first wiring L1. For example, assuming that the number of turns of the first wiring L1 is 100 and the number of turns of the second wiring L2 is 100, the turn ratio of the first wiring L1 to the second wiring L2 may be 1:1. Further, the whole of the second wiring L2 is selected, the driving voltage is generated corresponding to the number of turn of 1:1.

However, assuming that the turn number of the selected portion of the second wiring L2 through which the electric current flows is 50, the turn ratio of the first wiring L1 to the second wiring L2 may be 2:1. Thus, the magnitude of the drive voltage induced to the second wiring L2 may be varied. Although the turn numbers of the first wiring L1 and the second wiring L2 has been described to be equal, the present disclosure is not limited thereto. As an example, the turn number of the first wiring L1 may be set to be larger than that of the second wiring L2 or vice-verse. In addition, the second wiring L2 may include a first sub-wiring and a second sub-wiring. The control unit 120 selects one of the first and second sub-wirings and controls an electric current to flow through the selected sub-wiring. Then, the turn number of the second wiring L2 is decreased so that the turn ratio of the first wiring L1 to the second wiring L2 is adjusted. The adjustment of the electric current may include adjusting a flow direction of the electric current and regulating an amount of the electric current.

In some embodiments, the power supply unit 110 further includes a rectifying unit 130. The rectifying unit 130 is configured to rectify the driving voltage Vd which is induced from the second wiring L2 and supply the same to the load 101.

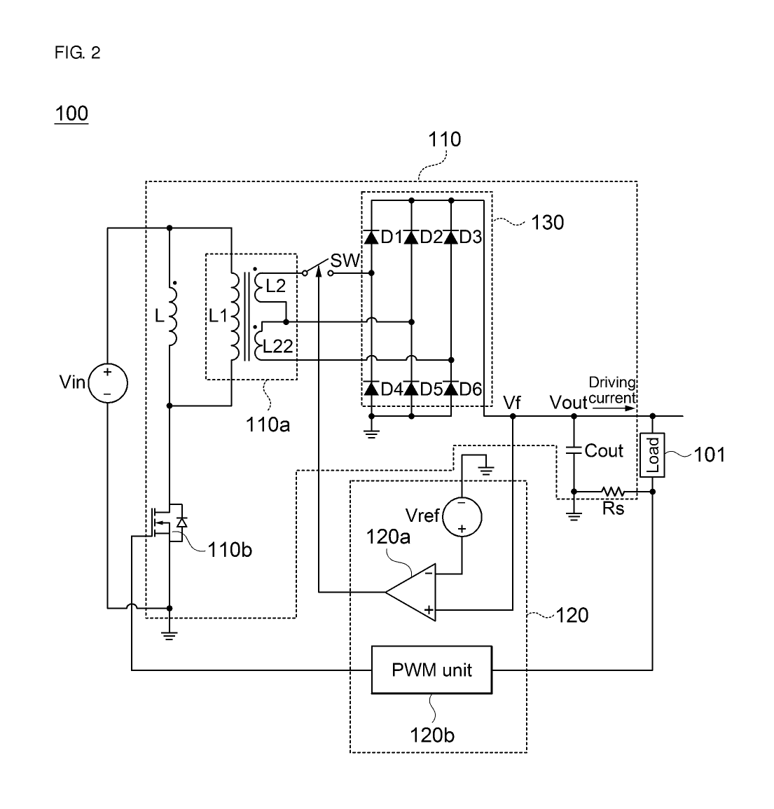

FIG. 2 is a circuit view of the power converter 100 shown in FIG. 1 according to a first embodiment.

As shown in FIG. 2, the power converter 100 includes a first wiring L1 connected to an input voltage Vin and a second wiring L2 to which the driving voltage is induced by an electric current flowing through the first wiring L1. The second wiring L2 includes a first sub-wiring L21 and a second sub-wiring L22. The rectifying unit 130 is connected to the first sub-wiring L21 and the second sub-wiring L22. A switch SW is disposed between the first sub-wiring L21 and the rectifying unit 130. The position of the switch SW is not limited thereto. In some embodiments, the switch SW may be disposed any positions as long as it selects one of the first sub-wiring L21 and the second sub-wiring L22 and forms a closed loop. Example of the switch SW may include a switching device such as a MOS transistor, a FET, a BJT or the like. The rectifying unit 130 includes a first diode D1 to a sixth diode D6. These diodes D1 to D6 are connected in a bridge fashion between the first sub-wiring L21 and the second sub-wiring L22. More specifically, a cathode electrode of the first diode D1 is connected to one terminal of the first sub-wiring L21 through the switch SW and an anode electrode thereof is connected to an output terminal Vout through the switch SW. A cathode electrode of the second diode D2 is connected to one terminal of the second sub-wiring L22 through the switch SW and an anode electrode thereof is connected to the output terminal Vout through the switch SW. A cathode electrode of the third diode D3 is connected to the other terminal of the second sub-wiring L22 through the switch SW and an anode electrode thereof is connected to the output terminal Vout through the switch SW. An anode electrode of the fourth diode D4 is connected to the one terminal of the first sub-wiring L21 through the switch SW and a cathode electrode thereof is connected to a ground. An anode electrode of the fifth diode D5 is connected to the one terminal of the second sub-wiring L22 through the switch SW and a cathode electrode thereof is connected to the ground. An anode electrode of the sixth diode D6 is connected to the other terminal of the second sub-wiring L22 through the switch SW and a cathode electrode thereof is connected to the ground.

An output capacitor Cout and the load 101 are connected to the output terminal Vout. The load 101 includes a plurality of LEDs connected in series. The load 101 is connected to a sensing resistor Rs. The sensing resistors Rs are configured to sense a voltage corresponding to the driving current flowing through the load 101.

In addition, the control unit 120 includes a comparator 120a. A positive terminal of the comparator 120a is connected to the output terminal Vout and a negative terminal thereof is connected to a reference voltage Vref. The comparator 120a outputs a control signal for comparing a voltage of the output terminal Vout with the reference voltage Vref and outputting the comparison result. The voltage of the output terminal Vout may be determined by the load 101 connected to the output terminal Vout. When the voltage of the output terminal Vout is higher than the voltage reference Vref, the switch SW is turned on according to the control signal. Meanwhile, when the voltage of the output terminal Vout is lower than the voltage reference Vref, the switch SW is turned off according to the control signal. In addition, the control unit 120 further includes a PWM unit 120b which is configured to control a duty ratio which corresponds to turn-on and turn-off intervals of the switch SW. The duty ratio may be determined based on a magnitude of the driving current flowing through the load 101. The PWM unit 120b is configured to adjust a flow of the electric current flowing through the first wiring L1 by controlling a duty ratio of a driving switch connected to the first wiring L1. While in the above, the driving switch has been described to be FET, the present disclosure is not limited thereto. As an example, the driving switch FET may include a switching device such as a MOS transistor, a BJT or the like. In the above, the control unit 120 has been described to control the duty ratio of the driving switch FET using the PWM unit 120b, but is not limited thereto. In some embodiments, the control unit 120 may adjust an on-off frequency of the driving switch FET such that the flow of the electric current flowing through the first wiring L1 is controlled.

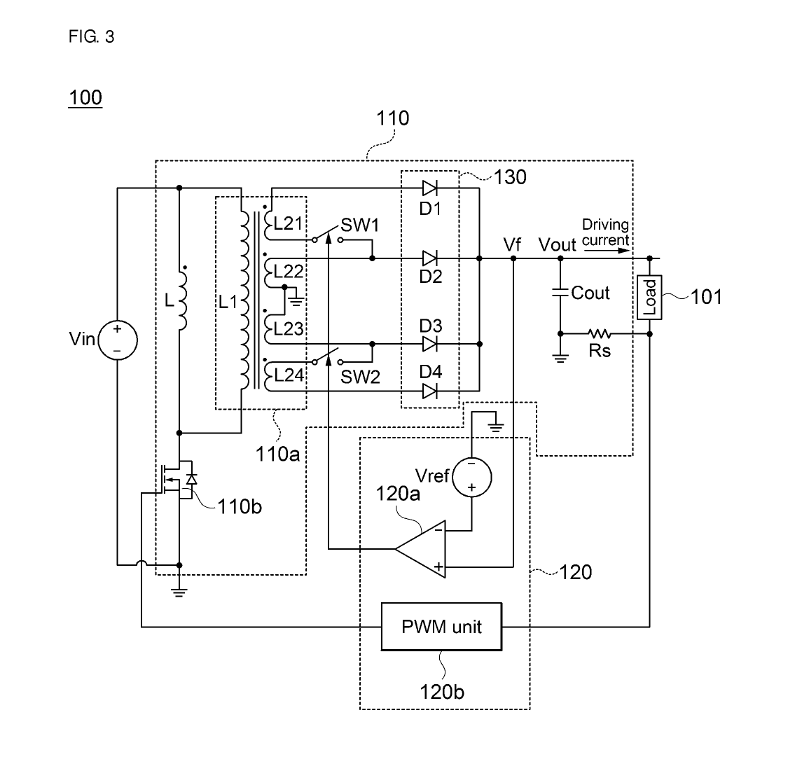

FIG. 3 is a circuit view of the power converter 100 shown in FIG. 1 according to a second embodiment.

As shown in FIG. 3, a power converter 100 includes a first wiring L1 connected to the input voltage Vin, and a second wiring L2 to which the driving voltage is induced by an electric current flowing through the first wiring L1. The second wiring L2 includes a first sub-wiring L21 to a fourth sub-wiring L24. A first switch SW1 is connected between the first sub-wiring L21 and the second sub-wiring L22. A second switch SW2 is connected between the third sub-wiring L23 and the fourth sub-wiring L24. Positions of the first switch SW1 and the second switch SW2 is not limited thereto. In some embodiments, the position of the first switch SW1 may be a position where a selected one of the first sub-wiring L21 and the second sub-wiring L22 forms a closed loop when the second switch SW1 is turned off. The position of the second switch SWs may be a position where a selected one of the third sub-wiring L23 and the fourth sub-wiring L24 forms a closed loop when the second switch SW2 is turned off. In addition, the first switch SW1 and the second switch SW2 may be a switching device such as a MOS transistor, a FET, a BJT or the like.

The first diode D1 is connected to the first sub-wiring L21. The second diode D2 is connected to the second sub-wiring L22. The third diode D3 is connected to the third sub-wiring L23. The fourth diode D4 is connected to the fourth sub-wiring L24. More specifically, a cathode electrode of the first diode D1 is connected to one terminal of the first sub-wiring L21 and an anode electrode thereof is connected to the output terminal Vout. A cathode electrode of the second diode D2 is connected to one terminal of the first switch SW1 and one terminal of the second switch SW2 and an anode electrode thereof is connected to the output terminal Vout. A cathode electrode of the third diode D3 is connected to one terminal of the third switch SW3 and the one terminal of the second switch SW2 and an anode electrode thereof is connected to the output terminal Vout. A cathode electrode of the fourth diode D4 is connected to one terminal of the fourth sub-wiring L24 and an anode electrode thereof is connected to the output terminal Vout. The first diode D1 to the fourth diode D4 may constitute the rectifying unit 130. The output capacitor Cout and the load 101 are connected to the output terminal Vout in parallel. The load 101 may include a plurality of LEDs connected in series. In addition, the load 101 is connected to a sensing resistor Rs where a voltage corresponding to the driving current flowing through the load 101 is sensed.

In addition, the control unit 120 includes a comparator 120a. A positive terminal of the comparator 120a is connected to the output terminal Vout and a negative terminal thereof is connected to the reference voltage Vref. The comparator 120a outputs a control signal for comparing a voltage of the output terminal Vout with the reference voltage Vref and outputting the comparison result. The voltage of the output terminal Vout may be determined by the load 101 connected to the output terminal Vout. When the voltage of the output terminal Vout is higher than the voltage reference Vref, the first and second switches SW1 and SW2 are simultaneously turned on according to the control signal. Meanwhile, when the voltage of the output terminal Vout is lower than the voltage reference Vref, the first and second switches SW1 and SW2 are simultaneously turned off according to the control signal. The term “simultaneously” used here may contain some time intervals. In addition, the control unit 120 further includes a PWM unit 120b configured to control a duty ratio which corresponds to turn-on and turn-off intervals of the switch SW. The duty ratio may be determined based on a magnitude of the driving current flowing through the load 101. The PWM unit 120b is configured to adjust a flow of the electric current flowing through the first wiring L1 by controlling a duty ratio of a driving switch connected to the first wiring L1. While in the above, the driving switch has been described to be FET, the present disclosure is not limited thereto. In the above, the control unit 120 has been described to control the duty ratio of the driving switch FET using the PWM unit 120b, but is not limited thereto. In some embodiments, the control unit 120 may adjust an on-off frequency of the driving switch FET such that the flow of the electric current flowing through the first wiring L1 is controlled. Furthermore, examples of the driving switch FET may be a switching device such as a MOS transistor, a BJT or the like.

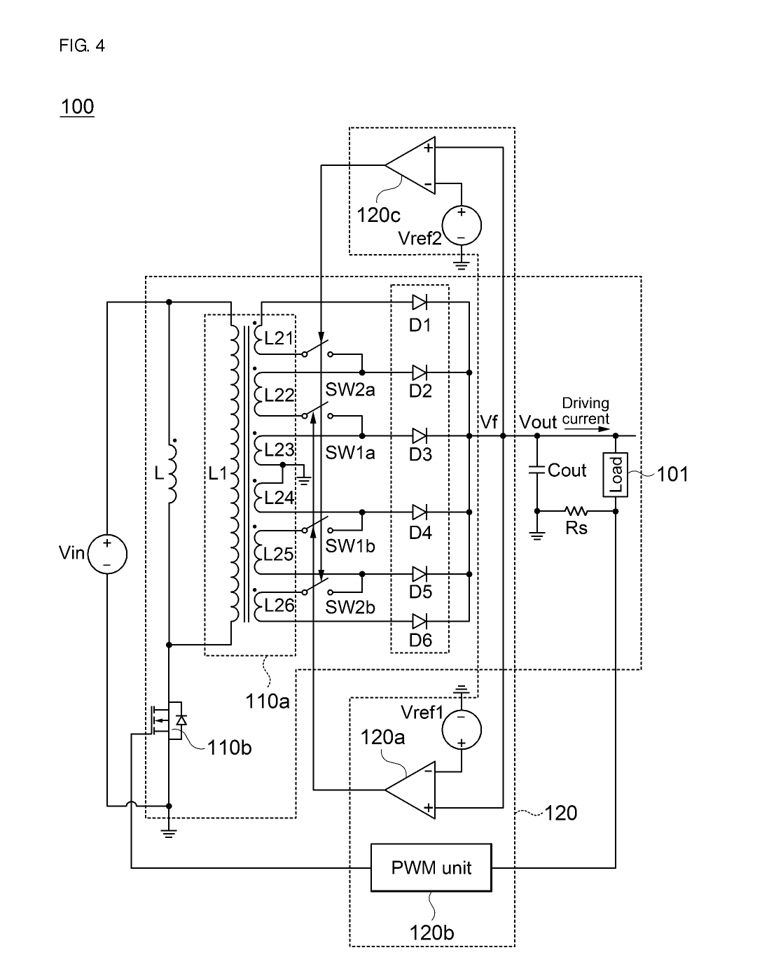

FIG. 4 is a circuit view of the power converter 100 shown in FIG. 1 according to a third embodiment.

As shown in FIG. 4, the power converter 100 includes a first wiring L1 connected to the input voltage Vin, and a second wiring L2 to which the driving voltage is induced by an electric current flowing through the first wiring L1. The second wiring L2 includes a first sub-wiring L21 to a sixth sub-wiring L26. A first switch SW1a is connected between the second sub-wiring L22 and the third sub-wiring L23. A second switch SW1b is connected between the fourth sub-wiring L24 and the fifth sub-wiring L25. A third switch SW2a is connected between the first sub-wiring L21 and the second sub-wiring L22. A fourth switch SW2b is connected between the fifth sub-wiring L25 and the sixth sub-wiring L26. When all the first switch SW1a to the fourth switch SW2b are turned off, only the third sub-wiring L23 and the fourth sub-wiring L24 are selected to form a closed loop.

When the first switch SW1a and the second switch SW1b are turned on and the third switch SW2a and the fourth switch SW2b are turned off, the second sub-wiring L22 to the fifth sub-wiring L25 are selected to form a closed loop. And, when the first switch SW1a to the fourth switch SW2b are turned on, the first sub-wiring L21 to the sixth sub-wiring L26 are selected to form a closed-loop. Positions of the first switch SW1a to the fourth switch SW2b are not limited thereto. As an example, the first switch SW1a to the fourth switch SW2b may be positioned at any locations as long as a turn number of the first sub-wiring L1 can be adjusted by selectively connecting the first sub-wiring L21 to the sixth sub-wiring L26 to one another. In addition, the first switch SW1 and the second switch SW2 may include a switching device such as a MOS transistor, a FET, a BJT or the like.

The first diode D1 is connected to the first sub-wiring L21. The second diode D2 is connected to the second sub-wiring L22. The third diode D3 is connected to the third sub-wiring L23. The fourth diode D4 is connected to the fourth sub-wiring L24. The fifth diode D5 is connected to the fifth sub-wiring L25. More specifically, a cathode electrode of the first diode D1 is connected to one terminal of the first sub-wiring L21 and an anode electrode thereof is connected to the output terminal Vout. A cathode electrode of the second diode D2 is connected to one terminal of the third switch SW3a and one terminal of the second sub-wiring L22 and an anode electrode thereof is connected to the output terminal Vout. A cathode electrode of the third diode D3 is connected to one terminal of the third sub-wiring L23 and the one terminal of the first switch SW1a and an anode electrode thereof is connected to the output terminal Vout. A cathode electrode of the fourth diode D4 is connected to one terminal of the fourth sub-wiring L24 and the second switch SW1b and an anode electrode thereof is connected to the output terminal Vout. A cathode electrode of the fifth diode D5 is connected to the other terminal of the fifth sub-wiring L25 and the fourth switch SW2b and an anode electrode thereof is connected to the output terminal Vout. A cathode electrode of the sixth diode D6 is connected to the other terminal of the sixth sub-wiring L26 and an anode electrode thereof is connected to the output terminal Vout. The first diode D5 to the sixth diode D6 may constitute the rectifying unit 130. The load 101 may include a plurality of LEDs connected in series. In addition, the load 101 is connected to the sensing resistor Rs where a voltage corresponding to the driving current flowing through the load 101 is sensed.

In addition, the control unit 120 includes a first comparator 120a. A positive terminal of the first comparator 120a is connected to the output terminal Vout and a negative terminal thereof is connected to a first reference voltage Vref1. The first comparator 120a outputs a first control signal for comparing a voltage of the output terminal Vout with the first reference voltage Vref1 and outputting the comparison result. The first control signal is applied to the first switch SW1a and the second switch SW1b such that they are simultaneously turned on or turned off. In addition, the control unit 120 includes a second comparator 120c. A positive terminal of the second comparator 120c is connected to the output terminal Vout and a negative terminal thereof is connected to a second reference voltage Vref2. The second comparator 120c outputs a second control signal for comparing a voltage of the output terminal Vout with the second reference voltage Vref2 and outputting the comparison result. The second control signal is applied to the third switch SW2a and the fourth switch SW2b such that they are simultaneously turned on or turned off.

Meanwhile, the first reference voltage Vref1 and the second reference voltage Vref2 may have different magnitudes of voltage. In addition, the second reference voltage Vref2 is higher than the first reference voltage Vref1. A voltage of the output terminal Vout is determined by the load 101 connected to the output terminal Vout. When the voltage of the output terminal Vout is lower than the first reference voltage Vref1, the first control signal and the second control signal allow both the first switch SW1a to the fourth switch SW4b to be turned off such that only the third sub-wiring L23 and the fourth sub-wiring L24 are selected. When the voltage of the output terminal Vout is higher than the first voltage reference voltage Vref1 and is lower than the second reference voltage Vref2, the first switch SW1 and the second switch SW2 are turned on such that the second sub-wiring L22 to the fifth sub-wiring L25 are selected.

Further, the voltage of the output terminal Vout is higher than the second reference voltage Vref2, the first switch SW1 and the second switch SW2 are turned on as the third switch SW2a and the fourth switch SW2b such that all the first sub-wiring L21 to the sixth sub-wiring L26 are selected. Thus, at least one of the first and second control signals is outputted according to the voltage of the output voltage Vout, thereby adjusting the turn number of the first wiring L2. In this way, the turn ratio of the first wiring L1 to the second wiring L2 can be adjusted. In addition, the control unit 120 further includes a PWM unit 120b configured to control a duty ratio which corresponds to turn-on and turn-off intervals of the switch. The duty ratio may be determined based on a magnitude of the driving current flowing through the load 101. The PWM unit 120b is configured to adjust a flow of the electric current flowing through the first wiring L1 by controlling a duty ratio of a driving switch connected to the first wiring L1. In the above, the control unit 120 has been described to control the duty ratio of the driving switch FET using the PWM unit 120b, but is not limited thereto. In some embodiments, the control unit 120 may adjust an on-off frequency of the driving switch FET such that the flow of the electric current flowing through the first wiring L1 is controlled. Further, while in the above, the driving switch has been described to be FET, the present disclosure is not limited thereto. As an example, the driving switch FET may include a switching device such as a MOS transistor, a BJT or the like.

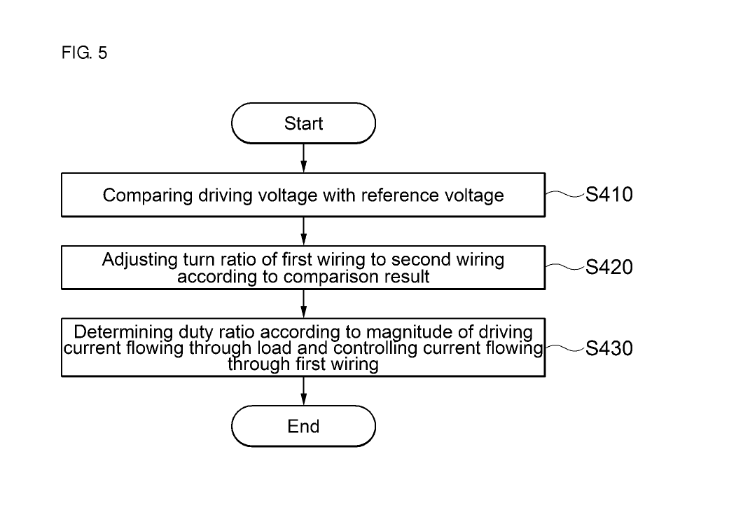

FIG. 5 is a flowchart showing a method for driving the power converter 100 shown in FIG. 1.

Referring to FIG. 5, in the power supply method of this embodiment, the driving voltage to be applied the load 101 is determined by the turn ratio of the first wiring L1 to the second wiring L2. The power supply method will be described using the power converter 100 shown in FIG. 3. First, comparison is performed on the driving voltage and the reference voltage (S410). At this time, it is assumed that the input voltage Vin of the power converter 100 is 100V and the reference voltage Vref is 90V. When the load 101 having a rated voltage of 100V is connected to the output terminal Vout (i.e., a plurality of LEDs each of which Vf voltage is 100V is connected to the output terminal Vout), the voltage of the output terminal Vout is 100V, whereby reference voltage Vref is higher than the voltage of the output terminal Vout. When the voltage of the output terminal Vout is higher than the reference voltage Vref, the comparator 120a outputs a control signal to turn on the switch. And, when the load 101 having a rated voltage of 50V is connected to the output terminal Vout, the voltage of the output terminal Vout becomes 50V so that the voltage of the output terminal Vout is lower than the reference voltage Vref. When the voltage of the output terminal Vout is lower than the reference voltage Vref, the comparator 120a outputs a control signal to turn on the switch.

In response to the comparison results, applying the driving current to a portion of the second wiring L2 is blocked such that the turn ratio of the first wiring L1 to the second wiring L2 is adjusted (S420). When the voltage of the output terminal Vout is higher than the reference voltage Vref and the first and second switches SW1 are turned on based on the control signal provided from the comparator 120a, voltages of the anode electrodes of the second diode D2 and the third diode D3 are set to be lower than voltages of the anode electrodes of the first diode D1 and the fourth diode D4 according to the turn ratio of the first wiring L1 to the second wiring L2. When the voltages of the anode electrodes of the second diode D2 and the third diode D3 are lower than the voltages of the anode electrodes of the first diode D1 and the fourth diode D4, the second diode D2 and the third diode D3 are rendered conductive so that a closed-loop is formed by the first sub-wiring L21 to the fourth sub-wiring L24 and the first diode D1 and the fourth diode D4. As a result, the turn ratio of the first wiring L1 to the second wiring L2 becomes 1:1. Thus, the driving voltage induced to the second wiring L2 becomes 100V so that a rated voltage of 100V is applied to the load 101. Therefore, LEDs whose Vf is 100V may be employed as the load. Further, when the voltage of the output terminal Vout is lower than the reference voltage Vref and the first switch SW1 and the second switch SW2 are turned off by the control signal provided from the comparator 120a, the first diode D1 and the fourth diode D4 are not connected to each other, thus forming a closed-loop by the second sub-wiring L22, the third sub-wiring L23, the second diode D2 and the third diode D3. As a result, the turn ratio of the first wiring L1 to the second wiring L2 becomes 2:1. Thus, the driving voltage induced to the second wiring L2 becomes 50V so that a rated voltage of 50V is applied to the load 101. Therefore, LEDs having Vf of 50V may be employed as the load. Accordingly, the range of the output voltage of the power converter 100 can be broaden by adjusting the turn ratio of the first wiring L1 to the second wiring L2.

Further, the control unit 120 controls the PWM unit 120b to adjust the electric current flowing through the first wiring L1. At this time, the PWM unit 120b adjust an amount of the electric current flowing through the first wiring L1 at a constant level using an amount of the driving current flowing through the load 101.

According to a power converter and a driving method therefor of the present disclosure, it is possible to broad a range of an output voltage of the power converter and connecting a load such as a LED module having various consumption powers to a single power converter, thus performing desired operations.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

1. A power converter, comprising:
a power supply unit provided with a first wiring and a second wiring and configured to apply a driving voltage to a load, the power supply unit being configured to adjust a magnitude of the driving voltage in response to a turn ratio of the first wiring to the second wiring; and
a control unit configured to output a control signal for control the turn ratio of the first wiring to the second wiring based on the magnitude of the driving voltage.

2. The apparatus of claim 1, wherein the second wiring includes a first sub-wiring and a second sub-wiring,
wherein a first switch is connected to one of the first sub-wiring and the second sub-wiring to selectively block a flow of an electric current to the one sub-wiring,
wherein the turn ratio of the first wiring to the second wiring is controlled with turn-on/turn-off operations of the first switch which are determined by the control signal.

3. The apparatus of claim 1, wherein the power supply unit further includes a rectifying unit,
wherein the rectifying unit is configured to rectify the driving voltage induced from the second wiring and provide the same to the load.

4. The apparatus of claim 2, wherein the control unit further includes a comparator,
wherein the comparator is configured to output the control signal in response to a magnitude relation between the reference voltage and the driving voltage.

5. The apparatus of claim 1, wherein the second wiring includes a first sub-wiring, a second sub-wiring, a third sub-wiring and a fourth sub-wiring,
wherein a first switch is connected to one of the first sub-wiring and the second sub-wiring to selectively block a flow of an electric current to the one sub-wiring, a second switch is connected to one of the third sub-wiring and the fourth sub-wiring to selectively block a flow of an electric current to the one sub-wiring,
wherein the turn ratio of the first wiring to the second wiring is adjusted with turn-on/turn-off operations of the first switch and the second switch.

6. The apparatus of claim 5, wherein the first switch and the second switch are simultaneously turned on or turned off based on the control signal.

7. The apparatus of claim 6, wherein the control unit further includes a comparator,
wherein the comparator is configured to output the control signal in response to a magnitude relation between the reference voltage and the driving voltage.

8. The apparatus of claim 1, wherein the second wiring includes a first sub-wiring, a second sub-wiring, a third sub-wiring, a fourth sub-wiring, a fifth sub-wiring and a sixth sub-wiring,
wherein the control signal includes a first control signal for controlling turn-on/turn-off operations of a first switch and a second switch, and a second control signal for controlling turn-on/turn-off operations of a third switch and a fourth switch,
wherein the power supply unit includes the first switch and the second switch which are turned off based on the first control signal such that an electric current is applied to a selected one of the third sub-wiring and the fourth sub-wiring, the first switch and the second switch being turned on based on the first control signal such that the electric current is applied to a selected one of the second sub-wiring to the fifth sub-wiring, and the third switch and the fourth switch which are turned on based on the second control signal such that the electric current is applied to a selected one of the first sub-wiring and the sixth sub-wiring.

9. The apparatus of claim 8, wherein the control unit further includes a first comparator and a second comparator,
wherein the second comparator is configured to output the first control signal in response to a magnitude relation between a first reference voltage and the driving voltage, and the second comparator is configured to output the second control signal in response to a magnitude relation between the driving voltage and a second reference voltage higher than the first reference voltage.

10. The apparatus of claim 1, wherein a fifth switch is provided to control a flow of electric current to the first wiring, and the control unit includes a PWM unit for detecting a magnitude of the driving current flowing through the load and adjusting a duty ratio of the fifth switch.

11. A power converter, comprising:
a first wiring through which an electric current flows in response to an input voltage;
a first sub-wiring to which a driving voltage is induced according to a variation in the electric current flowing through the first wiring;
a second sub-wiring to which the driving voltage is induced according to the variation in the electric current flowing through the first wiring;
a third sub-wiring to which the driving voltage is induced according to the variation in the electric current flowing through the first wiring;
a fourth sub-wiring to which the driving voltage is induced according to the variation in the electric current flowing through the first wiring;
a first switch connected between the other terminal of the first sub-wiring and one terminal of the second sub-wiring;
a second switch connected between the other terminal of the third sub-wiring and one terminal of the fourth sub-wiring;
a first diode connected between one terminal of the first sub-wiring and an output terminal;
a second diode connected between the first switch and the output terminal;
a third diode connected between the second switch and the output terminal;
a fourth diode connected between the other terminal of the fourth sub-wiring and the output terminal; and
a control unit configured to output a first control signal for controlling turn-on or turn-off operations of the first switch and the second switch.

12. The apparatus of claim 11, wherein the control unit further includes a first comparator configured to output the control signal to turn on or turn off the first switch and the second switch.

13. The apparatus of claim 11, further comprising:
a fifth sub-wiring to which the driving voltage is induced according to the variation in the electric current flowing through the first wiring;
a sixth sub-wiring to which the driving voltage is induced according to the variation in the electric current flowing through the first wiring;
a third switch connected between the fifth sub-wiring and one terminal of the first sub-wiring; and
a fourth switch connected between the fourth sub-wiring and one terminal of the sixth sub-wiring,
wherein the control unit further includes a second comparator configured to output a second control signal for controlling turn-on or turn-off operation of the third switch and the fourth switch,
the second comparator outputs the second control signal based on a voltage of the output terminal and a second reference voltage higher than the first reference voltage.

14. The apparatus of claim 11, wherein the control unit includes a PWM unit configured to control a flow of electric current flowing through the first wiring in response to a magnitude of a driving current flowing through the load from the output terminal.

15. A power supply method of determining a driving voltage to be applied to a load based on a turn ratio of a first wiring to a second wiring, the method comprising;
comparing the driving voltage with a reference voltage; and
adjusting the turn ratio of the first wiring to the second wiring by blocking a flow of a driving current to a portion of the second wiring based on the comparison result between the driving voltage with the reference voltage.

16. The method of claim 15, wherein the second wiring includes a first sub-wiring and a second sub-wiring,
wherein a switch is connected to one of the first sub-wiring and the second sub-wiring,
the switch being turned off based on the comparison result

17. The method of claim 15, further comprising:
determining a duty ratio based on a magnitude of the driving current flowing through the load; and
controlling the electric current flowing through the first wiring according to the duty ratio.
